(19) United States
(12) Patent Application Publication
(10) Pub. No.: US 2025/0017251 A1
(43) Pub. Date: Jan. 16, 2025

(54) DIETARY SUPPLEMENT CONTAINING CAYENNE PEPPER POWDER

(71) Applicant: PERFECT SPORTS INC., Vaughan (CA)

(72) Inventor: Jason Bell, Toronto (CA)

(21) Appl. No.: 18/752,018

(22) Filed: Jun. 24, 2024

Related U.S. Application Data
(60) Provisional application No. 63/522,855, filed on Jun. 23, 2023.

(51) Int. Cl. A23L 33/105; A23L 33/16; A23L 33/24

(52) U.S. Cl. CPC A23L 33/105; A23L 33/16; A23L 33/24

(57) ABSTRACT

Dietary supplements are described comprising a delayed release HPMC capsule containing, in combination, uncoated cayenne pepper fruit powder, enteric-coated capsaicinoids, peppermint leaf powder, and menthol. The dietary supplements provide desired effects of one or more of increasing metabolic rate and 24-hr REE (Resting Energy Expenditure), elevating Fatty Acid Release via lipolysis, promoting fat breakdown, TRPV1 Receptor activation, and increasing Heat Endogenous Production when ingested by a subject, while additionally improving tolerance by reducing potential discomfort upon ingestion.

### CROSS REFERENCE TO RELATED APPLICATIONS

This application claims the benefit of U.S. Provisional Application No. 63/522,855 filed Jun. 23, 2023, the disclosure of which is incorporated herein by reference.

### FIELD OF THE INVENTION

This invention relates to a dietary supplement comprising cayenne pepper powder, and more particularly to encapsulated dietary supplements comprising cayenne pepper powder and additional ingredients which decrease adverse effects which may be associated with ingestion of dietary supplements containing cayenne pepper powder and other pungent active agents.

### BACKGROUND

Capsaicin is the pungent principle associated with cayenne/red pepper. It is a prominent chemical entity in plants of Capsicum genus which includes chili peppers, red pepper, and paprika. Capsaicin is actually a class of compounds of branched and straight chain alkyl vannilamides. The antimicrobial and analgesic properties of capsaicin have been known for centuries. Other human studies and animal models report the weight reduction benefits of capsaicin. These studies show diet-induced thermo genesis (i.e., an increase in energy expenditure in the body) and a reduction in appetite levels (shown by decreased cumulative food intake) after consumption of Capsaicin from red peppers or their concentrated extracts. It also shows a beneficial reduction in body mass, percentage body fat, waist circumference, and a desirable reduction in levels of critical markers of weight maintenance such as blood glucose, insulin, triacylglycerol and leptin. All these point towards the immense potential for nutritionists to incorporate Capsicum and its active compounds.

Clinical studies have demonstrated that capsaicin can increase lipid oxidation, energy expenditure, and thermogenesis, leading to weight loss. It can also suppress appetite, increase satiety, and modulate the function of the gastrointestinal tract and gut microbiome. Additionally, capsaicin has been found to inhibit adipogenesis, promote brown adipose tissue activity, and enhance glucose metabolism. These effects are primarily mediated through the activation of transient receptor potential vanilloid 1 (TRPV1) channels.

Furthermore, capsaicin's anti-obesity effects are not limited to TRPV1 activation alone. It can also act through receptor-independent pathways, such as NF-KB inactivation and PPARγ activation. Capsaicin's role in adipocyte-to-adipocyte communication mediated by connexin43 (Cx43) has also been suggested.

Overall, the research supports the potential of dietary capsaicin consumption in reducing body weight, regulating metabolism, and improving metabolic health. The availability of capsaicin in chili peppers makes it a feasible and safe option for inclusion in weight management strategies.

Substances such as capsicum or capsicum extracts or capsaicin, however, are also extremely pungent and irritating to the skin and mucus membrane, and may not be well-tolerated by individuals in dietary supplement dosage forms at ingestion dosage concentrations desired for effectiveness. Use of capsicum or capsicum extracts or capsaicin in a polymer matrixed and/or enteric polymer coated free flowing solid particulate form has been described in Indian Pat. No. IN254661 and U.S. patent Ser. No. 10/813,967, and such materials are commercially available as CAPSIMAX™ available from OmniActive Health Technologies (India). Use of delayed release hydroxypropyl methylcellulose capsules (e.g., DRCaps™ available from Lonza) have also been suggested for use with pungent active agents. Such known techniques alone, however, may still not be sufficient to provide desired level of tolerance for dietary supplements containing high effective levels of capsaicinoids and other pungent additives.

It would be desirable to provide unique dietary supplements comprising capsaicin which further address requirements for facilitating administration of pungent active agents at doses adequate for nutritional and health benefits but which also further addresses the potential adverse reaction to ingestion of such pungent and irritating substances.

### SUMMARY

In accordance with one embodiment, a dietary supplement is described comprising a delayed release HPMC capsule containing, in combination, uncoated cayenne pepper fruit powder, enteric-coated capsaicinoids, peppermint leaf powder, and menthol.

In more specific embodiments, each capsule of the dietary supplement comprises from 50-400 mg of uncoated cayenne pepper fruit powder from cayenne peppers having 40,000-100,000 SHU, from 20-200 mg enteric-coated capsaicinoids at 2 wt % capsaicinoids, from 10-40 mg peppermint leaf powder, and from 1-20 mg menthol.

In a more specific embodiment, each capsule of the dietary supplement comprises from 50-200 mg of uncoated cayenne pepper fruit powder from cayenne peppers having 40,000-100,000 SHU, from 20-100 mg enteric-coated capsaicinoids at 2 wt % capsaicinoids, from 10-20 mg peppermint leaf powder, and from 1-10 mg menthol.

In a more specific embodiment, each capsule of the dietary supplement comprises about 100-125 mg of uncoated cayenne pepper fruit powder from cayenne peppers having 60,000-90,000 SHU, about 50 mg enteric-coated capsaicinoids at 2 wt % capsaicinoids, about 15 mg Peppermint leaf powder, and about 5 mg Menthol.

In each embodiment, each capsule of the dietary supplement may further comprise one or more additional active agents, including Niacin, Acetyl L-Carnitine, Ginger Root Extract, Grains of Paradise Seed Extract, Gamma Butyrobetaine Ethyl Ester Chloride, CH-19 Sweet Red pepper Fruit Extract, Fucoxanthin, and Black pepper fruit Extract, as well as various excipients including modified cellulose gum, vegetable stearates, silicon dioxide and titanium dioxide.

In further embodiments of the disclosure, a method for one or more of increasing metabolic rate and 24-hr REE (Resting Energy Expenditure), elevating Fatty Acid Release via lipolysis, promoting fat breakdown, TRPV1 Receptor activation, and increasing Heat Endogenous Production in a subject is described, comprising the subject ingesting one or more dietary supplement formulation capsules as summarized above and disclosed herein one or more time a day, and in a more specific embodiment ingesting a dose of 1-2 capsules once or twice a day.

### DETAILED DESCRIPTION

A dietary supplement is described comprising a delayed release HPMC capsule containing in combination uncoated cayenne pepper fruit powder, enteric-coated capsaicinoids, peppermint leaf powder, and menthol. In order to provide desired efficacy with regard to one or more of increasing metabolic rate and 24-hr REE (Resting Energy Expenditure), elevating Fatty Acid Release via lipolysis, promoting fat breakdown, TRPV1 Receptor activation, and increasing Heat Endogenous Production, while also minimizing adverse reactions upon ingestion, preferred ranges for such components in each capsule range from 50-400 mg of uncoated cayenne pepper fruit powder from cayenne peppers having 40,000-100,000 SHU, from 20-200 mg enteric-coated capsaicinoids at 2 wt % capsaicinoids, from 10-40 mg peppermint leaf powder, and from 1-20 mg menthol, with higher values in such ranges generally providing an effective full individual dosage.

In a more specific embodiment, each capsule of the dietary supplement may comprise lower values from the above ranges, e.g., from 50-200 mg of uncoated cayenne pepper fruit powder from cayenne peppers having 40,000-100,000 SHU, from 20-100 mg enteric-coated capsaicinoids at 2 wt % capsaicinoids, from 10-20 mg peppermint leaf powder, and from 1-10 mg menthol, and more specifically about 100-125 mg of uncoated cayenne pepper fruit powder from cayenne peppers having 60,000-90,000 SHU, about 50 mg enteric-coated capsaicinoids at 2 wt % capsaicinoids, about 15 mg Peppermint leaf powder, and about 5 mg Menthol. In such embodiments, a full effective dosage may comprise, e.g., 1-2 capsules.

In each embodiment, each capsule of the dietary supplement may further include additional active agents, including Niacin, Acetyl L-Carnitine, Ginger Root Extract, Grains of Paradise Seed Extract, Gamma Butyrobetaine Ethyl Ester Chloride, CH-19 Sweet Red pepper Fruit Extract, Fucoxanthin, and Black pepper fruit Extract, as well as various excipients including modified cellulose gum, vegetable stearates, silicon dioxide and titanium dioxide.

In more specific embodiments, each capsule of the dietary supplement may additionally comprise 10-60 mg Niacin, 100-1000 mg Acetyl L-Carnitine, 10-100 mg Ginger Root Extract standardized to 20 wt % Gingerols, 10-100 mg Grains of Paradise Seed Extract standardized to 12.5 wt % 6-Paradol, 10-100 mg Gamma Butyrobetaine Ethyl Ester Chloride, 5-50 mg CH-19 Sweet Red pepper Fruit Extract standardized to 0.75 wt % Capsiate, 2-20 mg Brown Seaweed extract standardized to 10 wt % Fucoxanthin, and 1-20 mg Black pepper fruit Extract standardized to 95 wt % piperine, with higher values in such ranges again generally providing an effective full individual dosage

In further specific embodiments, each capsule of the dietary supplement may additionally comprise 10-30 mg Niacin, 100-500 mg Acetyl L-Carnitine, 10-50 mg Ginger Root Extract standardized to 20 wt % Gingerols, 10-50 mg Grains of Paradise Seed Extract standardized to 12.5 wt % 6-Paradol, 10-50 mg Gamma Butyrobetaine Ethyl Ester Chloride, 5-50 mg CH-19 Sweet Red pepper Fruit Extract standardized to 0.75 wt % Capsiate, 2-10 mg Brown Seaweed extract standardized to 10 wt % Fucoxanthin, and 1-10 mg Black pepper fruit Extract standardized to 95 wt % piperine, and more specifically may additionally comprise 15-20 mg Niacin, about 300 mg Acetyl L-Carnitine, about 30 mg Ginger Root Extract standardized to 20 wt % Gingerols, about 20 mg Grains of Paradise Seed Extract standardized to 12.5 wt % 6-Paradol, about 20 mg Gamma Butyrobetaine Ethyl Ester Chloride, about 10 mg CH-19 Sweet Red pepper Fruit Extract standardized to 0.75 wt % Capsiate, 5-10 mg Brown Seaweed extract standardized to 10 wt % Fucoxanthin, and 2-3 mg Black pepper fruit Extract standardized to 95 wt % piperine. In such embodiments, a full effective dosage may comprise, e.g., 1-2 capsules, preferably taken once or twice a day.

The dietary supplements of the present disclosure are contained in delayed release HMPC capsules, such DRcaps™ capsules which are commercially available from Lonza. Such capsules are designed to be resistant to stomach acids, delaying release of the contents from approximately 30-60 minutes after ingestion, and can thus help reduce the adverse effects of pungent ingredients when ingested. While helpful for reducing adverse effects of pungent ingredients, use of such capsules alone may not completely eliminate all potential adverse effects for use of supplements containing high potency Cayenne pepper powders (e.g., having greater than about 40,000 SHU), particularly when such powders are used in combination with other pungent ingredients.

### EXAMPLES

Dietary supplements comprising mixtures of pungent ingredients including high potency Cayenne pepper powders (60,000-90,000 SHU) and red pepper fruit extracts, along with Niacin, Acetylcarnitine, Ginger Root Extract, Grains of Paradise Seed Extract, gamma-Butyrobetaine, Brown Seaweed Extract, and Black Pepper Fruit Extract, were prepared at sufficient concentrations to provide desired effects of one or more of increasing metabolic rate and 24-hr REE (Resting Energy Expenditure), elevating Fatty Acid Release via lipolysis, promoting fat breakdown, TRPV1 Receptor activation, and increasing Heat Endogenous Production when ingested. Even when provided in the form of HPMC delayed release capsules (DRCaps™ commercially available from Lonza) containing such effective amount of active ingredients including high potency Cayenne pepper powders, however, the dosages were sometimes not well-tolerated by users. Alternative formulations were developed and tested additionally comprising each of menthol and peppermint leaf powder, which were added to provide a cooling effect due in part to their independent action of TRPM8 receptors, and while some improvement in tolerance was observed, such formulations still were not effective in preventing temporary discomfort in all cases for the formulations when tested.

Further tests were performed with a further formulation as described in Table 1 below, again encapsulated in a HPMC delayed release capsule, wherein a portion of enteric-coated capsaicinoid free flowing powder was substituted for a portion of the high potency Cayenne pepper powder employed in previous test designed to provide desired efficacy, in addition to the inclusion of menthol and peppermint leaf powder.

TABLE 1
Formulation encapsulated in HPMC delayed release capsules
(DR Cap commercially available from Lonza)

| | Quantity per | | | |
|---|---|---|---|---|
| Component | Capsule Unit | | Potency | Source Material |
| Cayenne Pepper | 56.25 | mg | 60,000 SHU | Cayenne Pepper Fruit |
| powder (Capsicum | | | | |
| minimum) | | | | |
| Cayenne Pepper | 56.25 | mg | 90,000 SHU | Cayenne Pepper Fruit |
| powder (Capsicum | | | | |
| minimum) | | | | |
| Enteric-coated | 50 | mg | Standardized to | CAPSIMAX Cayenne Pepper |
| Capsaicinoid free | | | 2% Capsaicinoid | Fruit Extract |
| flowing powder | | | | |
| Niacin | 17.5 | mg | N/A | Nicotinic acid (Synthetic) |
| Acetylcarnitine | 300 | mg | N/A | Acetyl-L-Carnitine (Synthetic) |
| Ginger Root Extract | 30 | mg | Standardized to | Rhizome |
| (Zingiber officinale) | | | 20% Total gingerols | |
| Aframomum melegueta | 20 | mg | Standardized to | CALORIBURN Grains of |
| | | | 12.0% [6]-paradol | Paradise Seed Extract |
| Gamma- | 20 | mg | N/A | gamma-Butyrobetaine |
| Butyrobetaine Ethyl | | | | (Synthetic) |
| Ester Chloride (GBB) | | | | |
| CH-19 Sweet Red | 10 | mg | Standardized to | Sweet Red Pepper Fruit |
| Pepper Fruit Extract | | | 0.75% Capsaicin | |
| (Capsicum annuum) | | | | |
| Brown Seaweed | 7.5 | mg | Standardized to | |
| extract | | | 10.0% Fucoxanthin | |
| Black pepper | 2.5 | mg | Standardized to 95% | Piper nigrum - fruit |
| fruit Extract | | | Piperine | |
| (Piper nigrum) | | | | |
| Peppermint | 15 | mg | | |
| Leaf powder | | | | |
| Menthol | 5 | mg | | |

| | |
|---|---|
| Modified | excipient |
| Cellulose Gum | |
| Vegetable | excipient |
| Stearates | |
| Silicon Dioxide | excipient |
| Titanium Dioxide | excipient |

The addition of the peppermint and Menthol, in combination with the partial substitution of high potency Cayenne with enteric-coated capsaicinoid product CAPSIMAX™ in a delayed release HPMC capsule, was found effective at eliminating adverse reactions (stable results were obtained where 100% of subjects reported positive results across multiple tests based on a dosage of 2 capsules). The resulting combination leveraged the effect of an approximately 30-minute delay from the DRCaps™ capsules for substantially all ingredients, along with a portion of the capsaicinoid sources (i.e., the enteric-coated CAPSIMAX™ component) having a further delay that is based on the distinctive pH of the small intestine. Continued success of dietary supplement capsules of the formula of Table 1 created in this way was indicated by no negative reports from subjects testing the capsules while getting all of the positive effects noted throughout the testing. The formula is effective due to the ability for the ingredients to activate TRPV1 receptors, and create the effects of increased sweating and increased resting energy expenditure, without creating the discomfort associated with ingestion of the similar formulas not including the added menthol and peppermint leaf powder, and partial substitution of cayenne pepper powder with enteric-coated capsaicinoid, as subjects were able to tolerate the level of pungency that was previously problematic.

While examples have been described in connection with several presently preferred embodiments thereof, those skilled in the art will appreciate that many modifications and changes may be made without departing from the true spirit and scope of the invention which accordingly is intended to be defined solely by the appended claims.

1. A dietary supplement comprising an HPMC capsule containing therein:
uncoated cayenne pepper fruit powder;
enteric-coated capsaicinoids;
peppermint leaf powder; and
menthol.

2. The dietary supplement of claim 1, comprising:
50-400 mg of uncoated cayenne pepper fruit powder from cayenne peppers having 40,000-100,000 SHU;
20-200 mg enteric-coated capsaicinoids at 2 wt % capsaicinoids;
10-40 mg peppermint leaf powder; and
1-20 mg menthol.

3. The dietary supplement of claim 1, comprising:
50-200 mg of uncoated cayenne pepper fruit powder from cayenne peppers having 40,000-100,000 SHU;
20-100 mg enteric-coated capsaicinoids at 2 wt % capsaicinoids;
10-20 mg peppermint leaf powder; and
1-10 mg menthol.

4. The dietary supplement of claim 1, comprising:
about 100-125 mg of uncoated cayenne pepper fruit powder from cayenne peppers having 60,000-90,000 SHU;
about 50 mg enteric-coated capsaicinoids at 2 wt % capsaicinoids;
about 15 mg Peppermint leaf powder; and
about 5 mg Menthol.

5. The dietary supplement of claim 1, further comprising Niacin, Acetyl L-Carnitine, Ginger Root Extract, Grains of Paradise Seed Extract, Gamma Butyrobetaine Ethyl Ester Chloride, CH-19 Sweet Red pepper Fruit Extract, Fucoxanthin, and Black pepper fruit Extract.

6. The dietary supplement of claim 5, further comprising modified cellulose gum, vegetable stearates, silicon dioxide and titanium dioxide.

7. The dietary supplement of claim 5, comprising:
50-400 mg of uncoated cayenne pepper fruit powder from cayenne peppers having 40,000-100,000 SHU;
20-200 mg enteric-coated capsaicinoids at 2 wt % capsaicinoids;
10-40 mg peppermint leaf powder;
1-20 mg menthol;
10-60 mg Niacin, 100-1000 mg Acetyl L-Carnitine, 10-100 mg Ginger Root Extract standardized to 20 wt % Gingerols, 10-100 mg Grains of Paradise Seed Extract standardized to 12.5 wt % 6-Paradol, 10-100 mg Gamma Butyrobetaine Ethyl Ester Chloride, 5-50 mg CH-19 Sweet Red pepper Fruit Extract standardized to 0.75 wt % Capsiate, 2-20 mg Brown Seaweed extract standardized to 10 wt % Fucoxanthin, and 1-20 mg Black pepper fruit Extract standardized to 95 wt % piperine.

8. The dietary supplement of claim 5, comprising:
50-200 mg of uncoated cayenne pepper fruit powder from cayenne peppers having 40,000-100,000 SHU;
20-100 mg enteric-coated capsaicinoids at 2 wt % capsaicinoids;
10-20 mg peppermint leaf powder;
1-10 mg menthol;
10-30 mg Niacin, 100-500 mg Acetyl L-Carnitine, 10-50 mg Ginger Root Extract standardized to 20 wt % Gingerols, 10-50 mg Grains of Paradise Seed Extract standardized to 12.5 wt % 6-Paradol, 10-50 mg Gamma Butyrobetaine Ethyl Ester Chloride, 5-50 mg CH-19 Sweet Red pepper Fruit Extract standardized to 0.75 wt % Capsiate, 2-10 mg Brown Seaweed extract standardized to 10 wt % Fucoxanthin, and 1-10 mg Black pepper fruit Extract standardized to 95 wt % piperine.

9. The dietary supplement of claim 5, comprising:
about 100-125 mg of uncoated cayenne pepper fruit powder from cayenne peppers having 60,000-90,000 SHU;
about 50 mg enteric-coated capsaicinoids at 2 wt % capsaicinoids;
about 15 mg peppermint leaf powder;
about 5 mg menthol;
15-20 mg Niacin, about 300 mg Acetyl L-Carnitine, about 30 mg Ginger Root Extract standardized to 20 wt % Gingerols, about 20 mg Grains of Paradise Seed Extract standardized to 12.5 wt % 6-Paradol, about 20 mg Gamma Butyrobetaine Ethyl Ester Chloride, about 10 mg CH-19 Sweet Red pepper Fruit Extract standardized to 0.75 wt % Capsiate, 5-10 mg Brown Seaweed extract standardized to 10 wt % Fucoxanthin, and 2-3 mg Black pepper fruit Extract standardized to 95 wt % piperine.

10. A method for one or more of increasing metabolic rate and 24-hr REE (Resting Energy Expenditure), elevating Fatty Acid Release via lipolysis, promoting fat breakdown, TRPV1 Receptor activation, and increasing Heat Endogenous Production in a subject, comprising the subject ingesting a dietary supplement according to claim 1.

11. A method according to claim 10, comprising the subject ingesting 1 or 2 capsules of the dietary supplement, once or twice a day.

12. A method according to claim 10, comprising the subject ingesting a dosage of 2 capsules of the dietary supplement, once or twice a day.

13. A method according to claim 12, wherein each capsule contains about 100-125 mg of uncoated cayenne pepper fruit powder from cayenne peppers having 60,000-90,000 SHU; about 50 mg enteric-coated capsaicinoids at 2 wt % capsaicinoids; about 15 mg Peppermint leaf powder; and about 5 mg Menthol.

14. A method according to claim 13, wherein each capsule further contains 15-20 mg Niacin, about 300 mg Acetyl L-Carnitine, about 30 mg Ginger Root Extract standardized to 20 wt % Gingerols, about 20 mg Grains of Paradise Seed Extract standardized to 12.5 wt % 6-Paradol, about 20 mg Gamma Butyrobetaine Ethyl Ester Chloride, about 10 mg CH-19 Sweet Red pepper Fruit Extract standardized to 0.75 wt % Capsiate, 5-10 mg Brown Seaweed extract standardized to 10 wt % Fucoxanthin, and 2-3 mg Black pepper fruit Extract standardized to 95 wt % piperine.

15. A method according to claim 10, wherein the dietary supplement further comprises Niacin, Acetyl L-Carnitine, Ginger Root Extract, Grains of Paradise Seed Extract, Gamma Butyrobetaine Ethyl Ester Chloride, CH-19 Sweet Red pepper Fruit Extract, Fucoxanthin, and Black pepper fruit Extract.

16. A method according to claim 15, wherein the dietary supplement comprises:
50-400 mg of uncoated cayenne pepper fruit powder from cayenne peppers having 40,000-100,000 SHU;
20-200 mg enteric-coated capsaicinoids at 2 wt % capsaicinoids;
10-40 mg peppermint leaf powder;
1-20 mg menthol;
10-60 mg Niacin, 100-1000 mg Acetyl L-Carnitine, 10-100 mg Ginger Root Extract standardized to 20 wt % Gingerols, 10-100 mg Grains of Paradise Seed Extract standardized to 12.5 wt % 6-Paradol, 10-100 mg Gamma Butyrobetaine Ethyl Ester Chloride, 5-50 mg CH-19 Sweet Red pepper Fruit Extract standardized to 0.75 wt % Capsiate, 2-20 mg Brown Seaweed extract standardized to 10 wt % Fucoxanthin, and 1-20 mg Black pepper fruit Extract standardized to 95 wt % piperine.

17. A method according to claim 15, wherein the dietary supplement comprises:
50-200 mg of uncoated cayenne pepper fruit powder from cayenne peppers having 40,000-100,000 SHU;
20-100 mg enteric-coated capsaicinoids at 2 wt % capsaicinoids;
10-20 mg peppermint leaf powder;
1-10 mg menthol;
10-30 mg Niacin, 100-500 mg Acetyl L-Carnitine, 10-50 mg Ginger Root Extract standardized to 20 wt % Gingerols, 10-50 mg Grains of Paradise Seed Extract standardized to 12.5 wt % 6-Paradol, 10-50 mg Gamma Butyrobetaine Ethyl Ester Chloride, 5-50 mg CH-19 Sweet Red pepper Fruit Extract standardized to 0.75 wt % Capsiate, 2-10 mg Brown Seaweed extract standardized to 10 wt % Fucoxanthin, and 1-10 mg Black pepper fruit Extract standardized to 95 wt % piperine.

18. A method according to claim 15, wherein the dietary supplement comprises:
about 100-125 mg of uncoated cayenne pepper fruit powder from cayenne peppers having 60,000-90,000 SHU;
about 50 mg enteric-coated capsaicinoids at 2 wt % capsaicinoids;
about 15 mg peppermint leaf powder;
about 5 mg menthol;
15-20 mg Niacin, about 300 mg Acetyl L-Carnitine, about 30 mg Ginger Root Extract standardized to 20 wt % Gingerols, about 20 mg Grains of Paradise Seed Extract standardized to 12.5 wt % 6-Paradol, about 20 mg Gamma Butyrobetaine Ethyl Ester Chloride, about 10 mg CH-19 Sweet Red pepper Fruit Extract standardized to 0.75 wt % Capsiate, 5-10 mg Brown Seaweed extract standardized to 10 wt % Fucoxanthin, and 2-3 mg Black pepper fruit Extract standardized to 95 wt % piperine.
